(19) United States
(12) Patent Application Publication
(10) Pub. No.: US 2012/0287162 A1
(43) Pub. Date: Nov. 15, 2012

(54) METHOD FOR DISPLAYING LOCATION RELATED INFORMATION

(76) Inventors: Mehdi AMINIAN, Lausanne (CH); Andrea Coiro, Chavannes-Pres-Renens (CH); Octave Zangs, Lausanne (CH); Zeno Crivelli, Morges (CH)

(21) Appl. No.: 13/467,411

(22) Filed: May 9, 2012

(30) Foreign Application Priority Data
May 9, 2011 (CH) CH00788/11

(51) Int. Cl. G09G 5/00

(52) U.S. Cl. 345/660

(57) ABSTRACT

A method for displaying location related information on display (1) comprising:
scrolling and/or resizing a displayed electronic map (2) according to scrolling and/or resizing commands entered by a user,
displaying a virtual instrument (10) over the electronic map (2), comprising a pointer (12) and delimiting a portion (100) of the electronic which is changed when the electronic map (2) is scrolled and/or resized,
automatically displacing the pointer (12) within this portion (100) for pointing to a most relevant location (200) among all locations (20) in this portion (100),
displaying location related information (8, 5, 6, 16, A, B, C, D, C′, D′) about this most relevant location (200).

The method according to the invention allows a user to easily and quickly select a location and to get an instant and easy-to-read display of some location related information, e.g. weather forecast information.

### RELATED APPLICATIONS

This application claims priority to CH00788/11, filed May 9, 2011, the entire contents of which are hereby incorporated by reference.

### FIELD OF THE INVENTION

The present invention concerns a method for displaying location related information, comprising weather forecast information and/or ephemerides.

### DESCRIPTION OF RELATED ART

Nowadays electronic devices, e.g. portable devices as mobile phones, smart phones, laptops, personal computers, PDA (Personal Digital Assistant) etc., or non-portable devices as fixed computers, can execute some applications allowing them to display some location related information, e.g. weather forecast information and/or ephemerides.

In this context the expression “weather forecast information” indicates for example, without limitation, the temperature and/or the wind speed and/or the wind direction and/or the rain level and/or the pressure and/or the humidity forecast. The expression “ephemerides” indicates for example, without limitation, the sunshine duration and/or the moon phases and/or the sky iconography and/or the tide forecast.

Known weather applications lag in term of usability and readability: they do not offer an instant and easy-to-read display of the weather forecast for the current day or for the current week and often the user has to read and understand some quite complicated graphics. Moreover the user has to select a huge number of menus and sub-menus for knowing the weather forecast of a new location. In other words the selection of a new location is neither easy nor quick. Finally the known weather applications are then time cumbersome for the user.

There is then a need of a method for displaying location related information which allows a user to easily and quickly select a location and to get an instant and easy-to-read display of some location related information, e.g. weather forecast information and/or ephemerides.

### BRIEF SUMMARY OF THE INVENTION

It is an aim of the present invention to obviate or mitigate one or more of the aforementioned disadvantages.

It is an aim of the present invention to propose a method for displaying location related information which allows a user to easily and quickly select a location.

It is an aim of the present invention to propose a method for displaying location related information which allows a user to get an instant and easy-to-read display of some location related information, e.g. weather forecast information and/or ephemerides.

According to the invention, these aims are achieved by means of a method for displaying location related information on a display according to claim 1, by means of a computer-readable storage medium according to claim 13, by means of an electronic device for displaying one or more location related information according to claim 14 and by means of a server enabling one or more electronic devices to display one or more location related information according to claim 15.

The method for displaying location related information on a display according to the invention comprises the following steps:

displaying an electronic map on the display,

scrolling and/or resizing this electronic map according to scrolling and/or resizing commands entered by a user, so as to modify the area of the electronic map which is displayed,

displaying a virtual instrument over the electronic map comprising a pointer and delimiting a portion of the electronic map, this portion being changed when the electronic map is scrolled and/or resized,

automatically displacing the pointer within this portion for pointing to a most relevant location among all locations in the portion,

displaying location related information about this most relevant location on the display.

In this context the expression “electronic map” indicates an electronic visual representation of a geographic area. An electronic map can be a political map showing territorial borders, a satellite electronic map, a hybrid satellite electronic map, i.e. a satellite electronic map with locations' names, etc.

In this context the expression “scrolling and/or resizing commands” indicates commands entered by a user allowing him to scroll the electronic map, i.e. to move it vertically and/or horizontally and/or diagonally on the display, respectively to resize the electronic map, i.e. to change its size, e.g. by zooming-in or zooming-out.

The method according to the invention provides a very intuitive way for a user to retrieve location related information about the most relevant location in an area. The most relevant location can be the most populated location and/or the most cited location within an Internet search engine and/or the most cited location within an internet social network and/or the most touristic location and/or the capital city etc., among all the locations displayed within a portion of the electronic map delimited by a virtual instrument over this electronic map. This portion is changed when the electronic map is scrolled and/or resized by the user.

The virtual instrument, e.g. called the Atloscope, is in fact a virtual object having any close shape, i.e. having a shape allowing it to define the mentioned portion. For example its shape can be circular, triangular, square, rectangular, polygonal, ovoid, etc.

In a preferred embodiment the position and/or the size of the virtual instrument on the display is fixed and the user can scroll or resize the electronic map under this fixed virtual instrument. In another embodiment the user can scroll or resize the virtual instrument over a fixed electronic map. However in this last case the display's size has to be big enough and/or the electronic map has to be zoomed enough in order to display the desired locations. In another embodiment only the size of the virtual instrument can be changed by the user.

Advantageously the virtual instrument comprises a pointer which is automatically displaced within the mentioned portion of the electronic map for pointing to the most relevant location among all locations in this portion. The pointer is automatically and continually moved within this portion of the electronic map defined by the virtual instrument until when the most relevant location is pointed at and/or as long as the user is scrolling or zooming the underlying map. At the moment the most relevant location is pointed at and the user stops scrolling or zooming the underlying map, the pointer is automatically stopped. When the most relevant location is pointed at and the user is scrolling or zooming the underlying map, the pointer is locked on the pointed location but moves to continue to point to the locked location as long it is the most relevant location within the portion of the electronic map defined by the virtual instrument. The most relevant location is always instantly found and displayed above the virtual instrument; the pointer shows a slight inertia in moving to point at it: this pointer inertia is important to facilitate user's readability and comprehension.

In other words the pointer allows a discrete most relevant location selection which is automatically and continually performed while the electronic map (or the virtual instrument) is scrolled and/or resized.

According to the invention the selection of a location on the electronic map is very easy: the user just needs to move and scale the electronic map under the virtual instrument to automatically display a relevant location being continuously selected without having to pinpoint anything.

The following two steps have to be performed so as to allow the pointer to find the most relevant location:

comparing several locations displayed on the portion of the electronic map under the virtual instrument,

determining the most relevant location among all locations in the portion by using at least one criterion.

Possible criteria are

the most populated location,

the most cited location within an internet search engine,

the most cited location within an internet social network,

the most touristic location,

the capital city,

etc.

In a preferred embodiment the two steps allowing the pointer to find the most relevant location are locally performed, i.e. they are performed on an electronic device comprising the display which beforehand has downloaded from a server some information about some locations, e.g. the locations' names, population, longitude, latitude, altitude, time zone, etc., useful for defining the most relevant location. In this case the most relevant location is quickly found, but the electronic device must have a memory large enough for storing the information about the locations and for performing the necessary computations. According to this embodiment the current local time and date, the name and the altitude of the location pointed by the pointer, can change in real-time depending on the selected location on the electronic map as the user navigates through the electronic map.

In one embodiment only the information about some locations, e.g. the locations' names, population, longitude, latitude, altitude, time zone, etc., having a population superior to a threshold, e.g. superior to S residents, S being an integer and positive number, is locally stored. If the user enters zooming commands so as to display a portion of the map area under the virtual instrument comprising only locations having less than S residents, the pointer is automatically placed on a fixed position of the virtual instrument, e.g. its center, and the location related information is requested from a server.

In another embodiment these two steps are performed on a server linked to the electronic device by a wired and/or wireless connection. In this case the speed at which the most relevant location is displayed on the display depends on the connection between the server and the electronic device.

Once the pointer has pointed to a most relevant location within the portion of the electronic map defined by the virtual instrument and once the user does not enter on the display scrolling and/or resizing commands for a fixed delay, this delay being for example inferior to 5 seconds, location related information about the most relevant location, e.g. weather forecast information, are automatically displayed.

In one embodiment the weather forecast information is available in a memory of the electronic device comprising the display, i.e. it is locally stored. As previously discussed, in this case the weather forecast information is quickly found, but the electronic device must have a memory large enough for storing the weather forecast information and for performing the necessary computations. Moreover, since the weather forecast information can change periodically, for example every three hours, the electronic device has to periodically download from a server this weather forecast information. In one embodiment this download is performed only for some user's preferred locations.

In one embodiment only weather forecast information of the locations having a population superior to a threshold, e.g. superior to 3000 residents, is locally stored. If the user enters zooming commands so as to display a portion of the map area under the virtual instrument comprising only locations having less than 3000 residents, the pointer is automatically placed on a fixed position of the virtual instrument, e.g. its center, and the weather forecast information is requested from a server.

In a preferred embodiment the weather forecast information is received on-demand by the electronic device from a server through a wired and/or wireless connection. In this case the speed at which the location related information is displayed on the display depends on the connection between the server and the electronic device. However this embodiment allows to display weather forecast information which are always updated.

The mentioned delay, for example inferior to five seconds, between the absence of user scrolling and/or resizing commands and the display of the weather forecast information allows to avoid the method according to the invention to display weather forecast information of unwanted locations. In another embodiment the user can directly select the desired location, e.g. by a click of his mouse or finger, for avoiding this delay and almost immediately displaying the weather forecast information.

In one preferred embodiment the pointer is displaced within the virtual instrument according to some mechanical constraints: it is always perpendicular to the boundary of the virtual instrument and its length can dynamically vary in order to continuously and automatically point at the most relevant location.

In another embodiment a reticle, composed for instance of a horizontal and a vertical thin lines, can be used instead of the pointer with the intersection of such lines indicating the most relevant location.

The location related information, in particular the weather forecast information, is advantageously displayed in a very easy-to-read manner around the virtual instrument, so as anyone can read it easily and quickly. The location related information can be displayed by using text and/or icons and/or symbols and/or numbers. In one embodiment the text and/or icons and/or symbols and/or numbers corresponding to the current location related information, i.e. the weather forecast corresponding to the current hour or day or month, is displayed with text and/or icons and/or symbols and/or numbers with an augmented size.

In a preferred embodiment the virtual instrument is a virtual watch dial. The user has the possibility to change a skin, so as to change the aspect of his virtual watch dial. For example he can select the aspect of the virtual watch dial so as it can be the same than his real watch dial. In other words the virtual watch dial mimics the look and the physical behaviour of its corresponding real watch dial incarnation. The virtual watch dial has a virtual but rigorous mechanical nature. The current hour is displayed by using one or more hands. For readability reasons, the current hour can be further displayed outside the virtual watch dial in a numerical form.

According to one embodiment the user can change a function mode of the virtual instrument by rotating the bezel of this virtual watch dial. In other words the virtual watch dial has a rotating dial modes selector which allows it to select a “next/previous N hours” or a “next/previous M days” or a “next/previous P weeks” or a “next/previous R years” function mode, N, M, P and R being positive and integer numbers. In one preferred embodiment N=24 and M=7. In another embodiment a slider separated from the virtual instrument can be displayed allowing the user to select the next/previous hours or days or weeks or years.

The virtual instrument can display in a graphic form a diurnal and a nocturnal portion of the current day at the most relevant location, each of the portions corresponding to a different colour, for example white and black. In one embodiment the diurnal and nocturnal portions also indicate sunrise and sunset times.

In the “next 24 hours” mode the virtual instrument can display in a graphic form a “today” and a “tomorrow” portions corresponding to a different colour. The “today” and “tomorrow” portions can belong to an indicator ring. It is possible to display a “today” and a “yesterday” portions, for allowing the user to know the weather also of the previous day.

In the “next 7 days” mode the virtual instrument can display in a graphic form a “this week” and a “next week” portions corresponding to a different colour. The “this week” and “next week” portions can belong to an indicator ring similar to the previous described indicator ring for the “today” and “tomorrow” portions. Also in this case it is possible to display a “this week” and a “last week” portions, for allowing the user to know also the weather of the previous week. Same considerations are valid for “next/previous N hours” or “next/previous M days” or “next/previous P weeks” or “next/previous R years” function modes.

In another embodiment text or voice information, comprising encyclopaedic or user generated information related to the most relevant location is provided once the most relevant location is found, so as to provide a quick information overview about the most relevant location. An encyclopaedic mode, which for example can be selected by rotating the bezel of the virtual watch dial, can be provided for this text or voice information.

According to a preferred embodiment the provider of location related information can be selected automatically and/or according to the user location and/or to the most relevant location and/or user preferences.

### BRIEF DESCRIPTION OF THE DRAWINGS

The invention will be better understood with the aid of the description of an embodiment given by way of example and illustrated by the figures, in which:

FIG. 1 shows a view of a display displaying one embodiment of the virtual instrument of the method according to the invention, the virtual instrument being in a navigation state and in the “next 24 hours” mode.

FIG. 2 shows a view of a display displaying one embodiment of the virtual instrument of the method according to the invention, the virtual instrument being in a non-navigation state and in the “next 24 hours” mode.

FIG. 3 shows a view of a display displaying one embodiment of the virtual instrument of the method according to the invention, the virtual instrument being in a non-navigation state and in the “next 7 days” mode.

FIG. 4 shows the connection of several electronic devices with several provider of location related information by a proxy server.

### DETAILED DESCRIPTION OF POSSIBLE EMBODIMENTS OF THE INVENTION

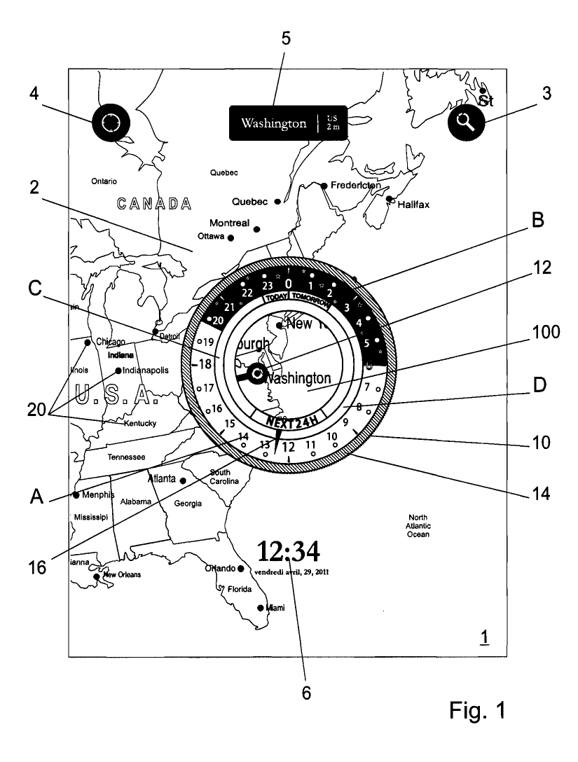

FIG. 1 shows a view of a display 1 displaying one embodiment of the virtual instrument 10 according to the invention. The display 1 can belong to an electronic device not shown, e.g. a portable device as a mobile phone, smart phone, laptop, personal computer, PDA (Personal Digital Assistant), tablet, wristwatch, etc., or to a non-portable device as a fixed computer. The display is preferably a touch display, preferably a multitouch display, although the invention can also be used with a conventional display associated with a mouse or other input means.

The display is displaying an electronic map 2, in this case a hybrid satellite electronic map, i.e. a satellite electronic map with the name of some locations.

In the illustrated embodiment, the virtual instrument 10 is displayed over the electronic map 2 at the center of the display 1 in a fixed position. The virtual instrument 10 comprises a pointer 12 and delimitates a portion 100 of the electronic map 2. The virtual instrument 10 in fact has a close shape, in this case a circular shape, allowing it to define the mentioned portion 100. Any close shape other than circular, e.g. triangular, square, rectangular, polygonal, ovoid, etc., can be imagined.

A user can scroll and/or resize the electronic map 2 by using scrolling and/or resizing commands entered in the electronic device comprising the display 1, so as to modify the area of the electronic map 2 which is displayed. The scrolling and/or resizing commands can be entered by the user by using haptic means. The expression “haptic means” indicates means performing a function once touched by a user or by a means as a stylus. Examples of haptic means comprise keys, push-buttons, a mouse or a touch screen. The portion 100 is then changed when the electronic map 2 is scrolled and/or resized by the user.

In the illustrated embodiment the position and the size of the virtual instrument 10 on the display 1 is fixed and the user can scroll or resize the electronic map 2 under this fixed virtual instrument 10. In another embodiment the user can scroll or resize the virtual instrument 10 over a fixed electronic map 2. In another embodiment only the size of the virtual instrument 10 can be changed by the user.

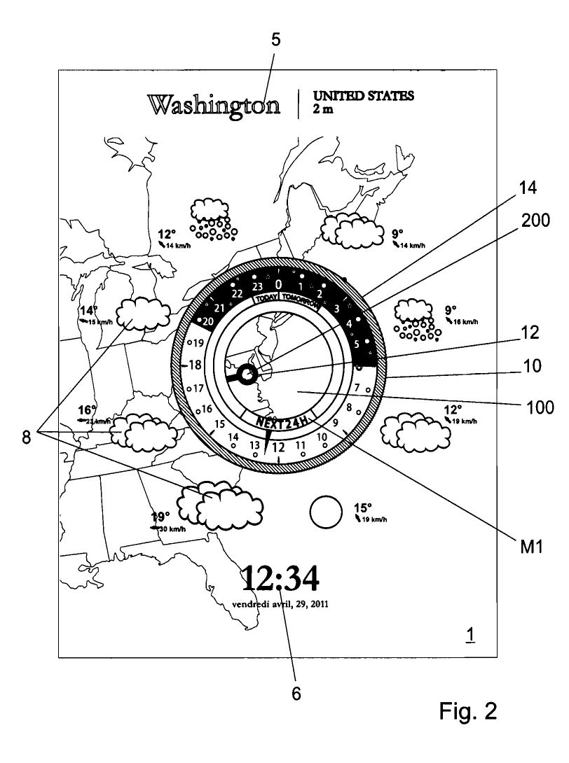

While the user is entering scrolling and/or resizing commands, i.e. he is in a “navigation state”, the pointer 12 is automatically displaced within the portion 100 for pointing to the most relevant location 200, illustrated in FIG. 2, among all locations in this portion 100. In other words the pointer 12 is automatically and continually moved within the portion 100 of electronic map 2 defined by the virtual instrument 10 until when the most relevant location 200 is pointed at. At this moment it is automatically locked on that location and can continue to move to stay locked while the user is entering scrolling and/or resizing commands and as long as 200 is the most relevant location. The pointer 12 then allows a discrete most relevant location selection which is automatically and continually performed while the electronic map 2 (or the virtual instrument 10) is scrolled and/or resized.

In one preferred embodiment the pointer 12 is automatically moved within the virtual instrument 10 according to some mechanical constraints: it is always perpendicular to the boundary of the virtual instrument 10 and its length can dynamically vary in order to continuously and automatically point at the most relevant location 200.

In another embodiment a reticle, composed for instance of a horizontal and a vertical thin lines, can be used instead of the pointer with the intersection of such lines indicating the most relevant location.

The following steps have to be performed so as to allow the pointer 12 to find the most relevant location 200:

comparing the locations displayed on the portion 100 of the electronic map 2 under the virtual instrument 10,

determining the most relevant location 200 among all locations in the portion 100 by using at least one criterion.

Possible criteria are

the most populated location,

the most cited location within an internet search engine,

the most cited location within an internet social network,

the most touristic location,

the capital city,

etc.

In a preferred embodiment the two steps allowing the pointer 12 to find the most relevant location are locally performed, i.e. they are performed on an electronic device comprising the display 1 which beforehand has downloaded from a server some information about some locations, e.g. the locations' names, population, longitude, latitude, altitude, time zone, etc., useful for defining the most relevant location. In this case the most relevant location 200 is quickly found, but the electronic device must have a memory big enough for storing the information about the locations and for performing the necessary computations.

According to this embodiment some location related information as the current local time and date 6 and 16, the name and the altitude of the location 5 pointed by the pointer, are displayed and can change in real-time depending on the selected location on the electronic map 2 as the user navigates through the electronic map 2.

The virtual instrument 10 of FIG. 1 displays in a graphic form a diurnal portion A and a nocturnal portion B of the next 24 hours at the most relevant location, each of the portions corresponding to a different colour, in this case white and black. The diurnal and nocturnal portions can also indicate sunrise and sunset times. The diurnal and nocturnal portions A and B can change in real-time depending on the selected location on the electronic map 2 as the user navigates through the electronic map 2.

The virtual instrument 10 of FIG. 1 displays in a graphic form also a “today” C and a “tomorrow” D portions corresponding to a different colour, for example bronze and steel. The “today” and “tomorrow” in the illustrated embodiment belong to an indicator ring. It is possible to display a “today” and a “yesterday” portions, for allowing the user to know the weather also of the previous day. The “today” and “tomorrow” portions C and D can also change in real-time depending on the selected location on the electronic map 2 as the user navigates through the electronic map 2.

In another embodiment only the information about some locations, e.g. the locations' names, population, longitude, latitude, altitude, time zone, etc., having a population superior to a threshold, e.g. superior to S residents, S being an integer and positive number, is locally stored. If the user enters zooming commands so as to display a portion 100 comprising only locations having less than S residents, the pointer 12 is automatically placed on a fixed position of the virtual instrument 10, e.g. its center, and the location related information is required to a server.

In another embodiment these two steps are performed on a server linked to the electronic device by a wired and/or wireless connection. In this case the speed at which the most relevant location 100 is displayed depends on the connection between the server and the electronic device.

If the most relevant location 200 does not correspond to a city but for example it is a location somewhere in the sea, the pointer 12 will be automatically moved in a fixed position within the virtual instrument, e.g. in its center, and the method according to the invention will display if available the location related information. The name associated with the selected location in this case will be “Somewhere” or a similar expression.

In the embodiment of FIG. 1 the virtual instrument is a virtual watch dial. The user has the possibility to change a skin, so as to change the aspect of his virtual watch dial. For example he can select the aspect of the virtual watch dial so as it can be the same of his real watch dial. In other words the virtual watch dial mimics the look and the physical behaviour of its corresponding real watch dial incarnation. The current hour is displayed by using one or more hands. In the illustrated example there is one hand 16. For readability reasons, the current hour can be further displayed outside the virtual watch dial in a numerical form, as indicated by the reference 6 on FIG. 1.

The reference 3 on FIG. 1 indicates a search function: one selected, the user can enter the name of the wanted location and the method according to the invention will displace the electronic map 2 under the virtual instrument 10 (or the virtual instrument 10 over the electronic map 2) and will resize the electronic map 2 (or the virtual instrument 10) until when the pointer 12 will point at this location within the portion 100. The reference 4 on FIG. 1 indicates a user geolocalization function.

Once the pointer 12 has pointed to a most relevant location 200 within the portion of the electronic map defined by the virtual instrument and once the user does not enter scrolling and/or resizing commands, so as to modify the displayed area of the electronic map 2, for a fixed delay, this delay being for example inferior to five seconds, location related information about the most relevant location 200, e.g. weather forecast information 8, are displayed, as illustrated on FIG. 2.

In the embodiment of FIG. 2, for readability reasons, all the locations' names of the electronic map 2 disappear as the weather forecast information 8 is displayed.

In one embodiment the weather forecast information 8 is available in a memory of the electronic device comprising the display 1, i.e. it is locally stored. As previously discussed, in this case the weather forecast information 8 is quickly found, but the electronic device must have a memory big enough for storing the weather forecast information 8 and for performing the necessary computations. Moreover, since the weather forecast information 8 can periodically change, for example every three hours, the electronic device has to periodically download it from a server.

In one embodiment only the weather forecast information 8 of the locations having a population superior to a threshold, e.g. superior to S residents, S being an integer and positive number, is locally stored. If the user enters zooming commands so as to display a portion 100 comprising only locations having less than S residents, the pointer 12 is automatically placed on a fixed position of the virtual instrument 10, e.g. its center, and the weather forecast information 8 is required to a server.

In another embodiment the weather forecast information 8 is received on-demand by the electronic device from a server through a wired and/or wireless connection. In this case the speed at which the weather forecast information 8 is displayed depends on the connection between the server and the electronic device. However this embodiment allows to display weather forecast information 8 which are always updated.

The mentioned delay, for example inferior to five seconds, between the absence of user scrolling and/or resizing commands and the display of the weather forecast information 8 allows to avoid the method according to the invention to display weather forecast information 8 of unwanted locations; in other words it allows to confirm the most relevant location found by the pointer is the location which interests to the user. In another embodiment the user can directly select the desired location, e.g. by a click of his mouse or his finger, for avoiding this delay and almost immediately displaying the weather forecast information 8.

The weather forecast information 8 is advantageously displayed in a very easy-to-read manner around the virtual instrument 10, so that anyone can read it easily and quickly. The location related information can be displayed by using text and/or icons and/or symbols and/or numbers. In the embodiment of FIG. 2 the symbols and numbers corresponding to the current hour are displayed with an augmented size. In FIG. 2 there are eight symbols around the virtual instrument 10, one each three hours, indicating the weather forecast. Beside each symbol there is the indication of the temperature, the wind speed and the wind direction. The number of used symbols can be fixed or can be determined by the user.

According to one embodiment the user can change a function mode from a function mode M1 to another function mode M2 of the virtual instrument by rotating the bezel 14 of this virtual watch dial, using for example drag commands on a touch display. In other words the virtual watch dial has a rotating dial modes selector 14 which allows it to select a “next/previous N hours” or a “next/previous M days” or a “next/previous P weeks” or a “next/previous R years” function mode, N, M, P and R being positive and integer numbers. In one preferred embodiment N=24 and M=7. In another embodiment a slider separated from the virtual instrument 10 can be displayed allowing the user to select the next/previous hours or days or weeks or years.

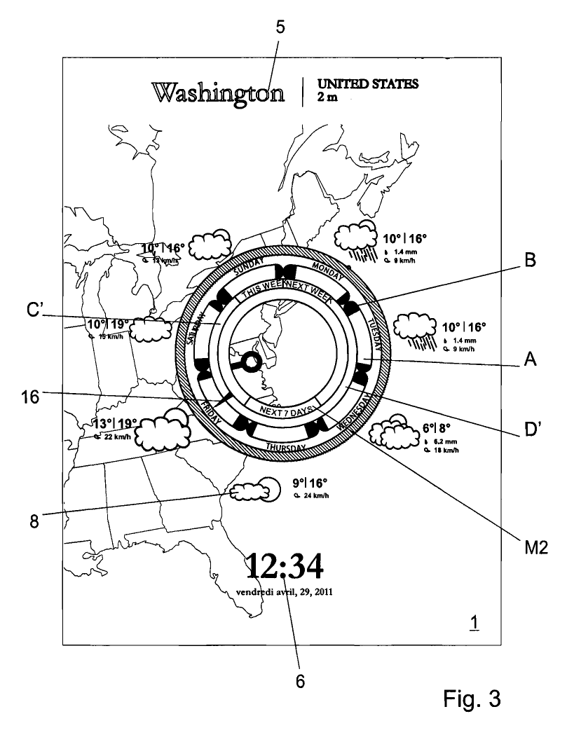

In the “next 7 days” mode, illustrated in FIG. 3, the virtual instrument 10 can display in a graphic form a “this week” and a “next week” portions C′ and D′, corresponding to a different colour, for example the same colours of the “today” respectively “tomorrow” portions or other two colours. The “this week” and “next week” portions C′ and D′ can belong to an indicator ring similar to the previous described indicator ring for the “today” and “tomorrow” portions C and D. Also in this case it is possible to display a “this week” and a “last week” portions, for allowing the user to know also the weather of the previous week.

A “more than 7 days” mode can be also imagined, in which the indicator ring, the ephemerides and the time are similar than in the illustrated “24 hours” mode.

In another embodiment text or voice information, comprising encyclopaedic or user generated information related to the most relevant location 200 is provided so as to give a quick information overview about the most relevant location 200. An encyclopaedic mode, which for example can be selected by rotating the bezel 14 of the virtual watch dial 10, can be provided for this text or voice information.

In another embodiment the location related information comprises a graphic of the temperature and/or pressure and/or wind speed variation displayed outside the virtual instrument 10, e.g. in the form of a virtual paper band similar to the seismographic paper band.

In another embodiment the location related information comprises hotel and/or cinema and/or hospitals and/or museums and/or points of interest information.

The pointer 12 can be used also for learning goals, for example for knowing the most populate city of the Middle-East or of the Australia, by using appropriated scrolling and sizing commands.

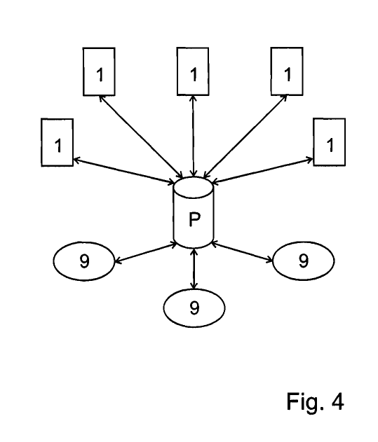

FIG. 4 shows the connection of several electronic devices, each device comprising a display 1, with several location related information providers 9 by means of a server P, i.e. a computer system or an application. The server P is a proxy server, i.e. a server that acts as an intermediary for requests from several electronic devices seeking resources from other servers, i.e. the servers of the location related information providers 9.

In one embodiment the server P performs at least one of the following functions:

Harmonizing the information received from the providers 9, e.g. homogenizing the units of measurement of the temperature, pressure, etc., the page settings, the code languages used by the different providers 9.

Translating the different code languages from the providers 9 in a languages useful for communicating with the electronic devices and which makes the communication effective.

Extracting only the useful information from the information received from the providers 9, which are often redundant, in order to have the most effective communication with the electronic devices.
Managing the requests from different electronic devices: in fact the server P advantageously can have a memory, e.g. a cache memory, for storing for a predetermined time the requests of the electronic devices 1 and/or the informations from the providers 9. If for example two different electronic devices 1 ask for the weather forecast of the same location, the server P can send only one request to a provider 9.

Partitioning the electronic map in little areas, e.g. in squares having a surface of some Km², and considering the weather forecast inside each area constant, for optimizing for example the requests of two users living in two different parts of the same area.

Comparing the locations displayed on the portion 100 of the electronic map 2 under the virtual instrument 10 and determining the most relevant location among all locations in the portion 100 by using some criteria.

In this last case the server P comprises

a receiver for receiving from one or more electronic devices the position of a virtual instrument 10 on an electronic map 2, the scrolling and/or resizing commands entered by a user of the one or more electronic devices and the size of the virtual instrument 10,

a first module for comparing data related to the locations displayed on the portion 100 of the electronic map 2 delimited by the virtual instrument 10,

a second module for determining a most relevant location 200 among all locations in this portion by using at least one of the following finding criteria:

most populated location

most cited location within an internet search engine

most cited location within an internet social network

most touristic location

capital city

ect.

a transmitter for transmitting to the one or more electronic devices the most relevant location 200.

The first and second module can comprise at least one processor, such as one or more digital signal processors (DSPs), general purpose microprocessors, application specific integrated circuits (ASICs), field programmable logic arrays (FPGAs), or other equivalent integrated or discrete logic circuitry. The first and second module can be the same module.

According to a preferred embodiment the location related information provider P can be selected automatically and/or according to the user location and/or to the most relevant location 200 and/or user preferences. For example a Swiss user can decide to use a Swiss provider P for knowing the weather forecast in New York instead of the automatically proposed provider P. According to another example the provider P most used by the residents in New York can be automatically proposed or selected by the user.

The invention concerns also a computer-readable storage medium for displaying one or more location related information on a display 1, encoded with instructions for causing a programmable processor for performing the described method.

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

Various examples have been described. These and other examples are within the scope of the following claims.

It is to be understood that the claims are not limited to the precise configuration and components illustrated above. Various modifications, changes and variations may be made in the arrangement, operation and details of the methods and apparatus described above without departing from the scope of the claims.

### REFERENCE NUMBERS USED ON THE FIGURES

1 Display
2 Electronic map
3 Search function
4 User geolocalization function
5 Location name
6 Current time and/or current date
8 Weather forecast information
9 Location related information provider
10 Virtual instrument
12 Pointer
14 Bezel
16 Current time hand
20 Location
200 Most relevant location
100 Portion of the electronic map
A Diurnal portion of the virtual instrument
B Nocturnal portion of the virtual instrument
C Current day portion of the virtual instrument
D Next day portion of the virtual instrument
C′ Current week portion of the virtual instrument
D′ Next week portion of the virtual instrument
M1 First function mode
M2 Second function mode
P Proxy server

1. A method for displaying location related information on display (1) comprising:
displaying an electronic map (2) on said display (1),
scrolling and/or resizing said electronic map (2) according to scrolling and/or resizing commands entered by a user, so as to modify the area of said electronic map (2) which is displayed,
displaying a virtual instrument (10) over said electronic map (2), said virtual instrument (10) comprising a pointer (12) and delimiting a portion (100) of said electronic map (2), wherein said portion (100) is changed when said electronic map is scrolled and/or resized,
automatically displacing the pointer (12) within said portion (100) of the electronic map (2) for pointing to a most relevant location (200) among all locations (20) in said portion (100) of said electronic map (2),
displaying location related information (8, 5, 6, 16, A, B, C, D, C′, D′) about said most relevant location (200) on said display (1).

2. The method of claim 1, said one or more location related information comprising weather forecast information (8) and/or ephemerides.

3. The method of claim 1, wherein the position and/or the size of said virtual instrument (10) on said display (1) is fixed or wherein the position and/or the size of said virtual instrument (10) on said display (1) can be changed by the user.

4. The method of claim 1, comprising
comparing the locations (20) displayed on said portion (100) of said electronic map (2),
determining said most relevant location (200) by using at least one of the following finding criteria:
most populated location
most cited location within an internet search engine
most cited location within an internet social network
most touristic location
capital city.

5. The method of claim 1, said one or more location related information comprising at least one of the following information: locations' names (5); locations' geographical positions; locations' current time or date (6, 16); locations' population.

6. The method of claim 1, comprising
automatically updating the pointer (12) position while the virtual instrument (10) and/or the electronic map area (2) are moved and/or changed and/or scaled.

7. The method of claim 1, wherein said virtual instrument (10) is a virtual watch dial.

8. The method of claim 7, comprising
changing by a user a skin, so as to change the aspect of said virtual watch dial.

9. The method of claim 7, comprising
changing by a user a function mode of said virtual instrument (10) by rotating a bezel (14) of said virtual watch dial.

10. The method of claim 1, wherein said virtual instrument (10) displays in a graphic form a diurnal (A) and a nocturnal (B) portion of the day at said most relevant location (200) and/or a today (C) and a tomorrow (D) portions and/or a this week (C′) and a next week (D′) portions each of said portions (A; B; C; D; C′; D′) corresponding to a different colour.

11. The method of claim 1, comprising
automatically selecting a provider (9) of location related information according to the user location and/or to the most relevant location (200) and/or user preferences.

12. The method of claim 1, wherein said electronic map (2) is displayed as a background image on said display (1),
wherein said virtual instrument (10) has a ring shape, wherein said portion (100) delimitated by said ring shape is a circular region of said electronic map (2) within said ring,
wherein location related information is displayed over said electronic map (2) outside of said ring,
wherein additional location related information, including local time and/or local duration of day and night, is displayed with different colour segments of said ring.

13. A computer-readable storage medium for displaying one or more location related information on a display (1), encoded with instructions for causing a programmable processor for performing the method of claim 1.

14. An electronic device for displaying one or more location related information comprising
a display (1) for displaying an electronic map (2) and for displaying location related information (8, 5, 6, 16, A, B, C, D, C′, D′) about a most relevant location (200) among all locations (20) in a portion (100) of said electronic map (2);
haptic means for scrolling and/or resizing said electronic map (2) by a user, so as to modify the area of said map which is displayed,
a first module for displaying a virtual instrument (10) over said electronic map (2), said virtual instrument (10) comprising a pointer (12) and delimiting said portion (100) of said electronic map (2), wherein said portion (100) is changed when said electronic map (2) is scrolled and/or resized,
a second module for automatically displacing the pointer (12) within said portion (100) of the electronic map (2) for pointing to the most relevant location (200).

15. A server enabling one or more displays (1) to display one or more location related information comprising
a receiver for receiving from one or more electronic devices (1) the position of a virtual instrument (10) on an electronic map (2), the scrolling and/or resizing commands entered by a user of said one or more displays (1) and the size of said virtual instrument (10)
a third module for comparing one or more data (5, 6) related to the locations displayed on a portion (100) of said electronic map (2) delimited by said virtual instrument (10),
a fourth module for determining a most relevant location (200) among all locations (20) in said portion (100) by using at least one of the following finding criteria:
most populated location
most cited location within an Internet search engine
most cited location within an internet social network
most touristic location
capital city
a transmitter for transmitting to said one or more electronic devices said most relevant location (200).
